(19) United States
(12) Patent Application Publication
(10) Pub. No.: US 2024/0309842 A1
(43) Pub. Date: Sep. 19, 2024

(54) METHODS AND SYSTEMS OF GLOBALLY REFERENCED NACELLE YAW POSITION CONTROL OF A WIND TURBINE FOR WIND PLANT FLOW CONTROL

(71) Applicant: WindESCo, Inc., Boston, MA (US)

(72) Inventors: Danian Zheng, Boston, MA (US); Nathan L. Post, Portland, ME (US); Aaron Hall, Boston, MA (US); Karthikeyan Appuraj, Boston, MA (US); Peter Bachant, Cambridge, MA (US)

(21) Appl. No.: 18/599,572

(22) Filed: Mar. 8, 2024

Related U.S. Application Data
(60) Provisional application No. 63/452,890, filed on Mar. 17, 2023.

(51) Int. Cl. F03D 7/02

(52) U.S. Cl. CPC F03D 7/0204; F05B 2270/1095; F05B 2270/321; F05B 2270/329

(57) ABSTRACT

Systems and methods of driving a nacelle to a target nacelle yaw position are provided in which an auxiliary yaw position control system is coupled to a turbine control unit. The auxiliary yaw position control system receives a first signal representing a current nacelle yaw position and a second signal representing a target nacelle yaw position. The auxiliary yaw position control system determines, based upon the current nacelle yaw position and the target nacelle yaw position, whether and in which direction the nacelle needs to move to be in the target nacelle yaw position and sends nacelle yaw actuation signals to the turbine control unit. If it is safe to accept the nacelle yaw actuation signals, the auxiliary yaw position control system commands the yaw drive so it moves to the target nacelle yaw position.

### CROSS-REFERENCE TO RELATED APPLICATION

This application is a non-provisional of and claims priority to U.S. Patent Application No. 63/452,890, filed Mar. 17, 2023, which is hereby incorporated by reference in its entirety.

### FIELD

The present disclosure relates to advanced yaw control of wind turbines.

### BACKGROUND

Wind turbines do not generally provide the ability to drive the nacelle to specific yaw positions. Rather, they work by closing the loop on the measured relative wind direction by commanding the yaw drives such that the relative wind direction stays close to zero. The relative wind direction is determined using a vane or sonic anemometer or other sensor (e.g. LIDAR) mounted on the nacelle that can detect the relative wind direction in close proximity to the turbine nacelle. While reasonably successful for lone operation of a single turbine, this has significant drawbacks when it comes to achieving wind farm flow control such as wake steering and collective and predictive yaw control where the turbines work together to achieve better power performance and reduced loads overall across the wind plant. These strategies seek to mitigate some of the wake losses and best position all the turbines to capture as much combined energy as possible.

Because wind turbines drive their nacelle position using the local yaw error (the magnitude and direction of the relative wind signal measured by the turbine) as the feedback error which the controller attempts to drive to zero by turning the nacelle, wind plant flow control systems to date have generally been implemented using a dynamic yaw error offset added to the relative wind direction feedback signal from the sensor. This is relatively straightforward to implement and ensures that the turbine behaves as it did prior to the modification when the offset is zero.

However, there are several distinct drawbacks. One is accuracy. The wind is continuously changing and may shift locally for short periods of time. Often the turbine control unit will track this change but will be behind it. When the relative wind direction signal (yaw error) is used as feedback in the yaw controller plus or minus an offset, the turbine control unit yaw controller will respond to changes in local wind direction measured and thus, the nacelle yaw position will not accurately match the optimized nacelle yaw position for wind farm flow control.

Another drawback is speed. To damp out the attempt to track short duration changes in wind direction, the yaw controller on a turbine must filter the yaw error signal heavily and thus responds slowly to changes in wind direction. It will also respond slowly to changes in the dynamic offset. Because the wind farm flow control algorithms are taking a great deal of information into account across the windfarm both spatially and temporally, this additional filtering or damping is not desirable, and the nacelle should optimally go to the new target nacelle orientation as quickly as possible to ensure continued energy recovery from wake mitigation.

A third disadvantage of driving nacelle yaw position using the local yaw error is feedback. That is, the local wind direction measurement may not accurately reflect the angle of the turbine to the incoming wind speed, particularly when the turbine is yawed relative to that flow field. This is because the nacelle and wind direction sensor are downstream of the rotor, which is now deflecting the wake. While the turbine can drive to zero yaw error reasonably accurately (with a static offset), the dynamic offset required to achieve a particular angle to the incoming wind may be a non-linear function of the measured relative wind direction angle, further complicating accurate control.

For the above reasons, Applicant previously developed a retrofit system that can control the nacelle position yaw angle relative to a fixed reference frame (typically True North) by providing a virtual relative wind direction to the nacelle controller in place of the real feedback signal. Embodiments of this retrofit system are described and claimed in U.S. Pat. No. 11,313,351, issued Apr. 26, 2022, and U.S. Pat. No. 11,680,556, issued Jun. 20, 2023, each of which is hereby incorporated by reference herein in its entirety. This system and method are more precise and accurate then the aforementioned yaw error offset-based control, but there remains room for improvement in both speed and accuracy by the responsiveness of the yaw drive controller. Embodiments disclosed and claimed herein can be used with the retrofit systems described in these patents.

Thus, there is a need for more advanced systems and methods of yaw control for wind turbines. There is a need for globally referenced yaw position control for a wind turbine. There also is a need for systems and methods of yaw control that increase the speed, accuracy, and responsiveness of the yaw drive controller.

### SUMMARY

Embodiments of the present disclosure improve the speed and accuracy further by opening a direct communication with the turbine yaw controller, i.e., turbine control unit, that overrides the existing feedback loop on relative wind direction as measured on the wind turbine. The present disclosure describes placing an additional electronic control system on the wind turbine or at the wind plant that is communicatively coupled with the turbine control unit, receiving information about the present status of the wind turbine.

Two types of control are described herein. First, digital outputs indicate that the wind turbine should turn left, turn right, or stay where it is and provide the system status as either follow these commands or follow the relative wind direction. The additional system must then close the loop to drive the nacelle to the target position as described herein. The second type of control is direct nacelle yaw position commands. Using a communication protocol capable of transmitting numerical values, the target nacelle yaw position and potentially the current nacelle position are provided to the turbine control unit, which then closes the loop on the nacelle position.

When conditions are not suitable for wind plant control or a fault or error in the system exists, then the communication signal to the wind turbine will indicate that this is the case, and the turbine control unit returns to the default behavior of using the measured relative wind direction signal as feedback.

The disclosed systems and methods enable more precise wind plant flow control by both accurately measuring the wind across the wind plant, enabling modeling of that wind flow field, and optimization of the turbines to it and then driving the turbines to the required positions. By measuring the precise turbine nacelle positions in a global reference frame, uncertainty in both the wind direction and the present nacelle yaw position of each turbine is reduced. Using information from upstream wind turbines it is possible for the plant optimization to drive nacelles to the needed positions when they need to be there. By driving wind turbine nacelles to the target positions as quickly as possible, energy capture losses are reduced, and an optimized system does not need to anticipate future wind direction changes as far in advance, further reducing the uncertainty.

Disclosed systems can be coupled with an analysis process that determines if individual turbines have a sensor misalignment that results in the relative wind direction not being accurately measured on a given turbine. This can then be considered when determining the overall wind flow field and thus the optimum nacelle positions. Furthermore, when a turbine is intentionally or unintentionally misaligned to the wind, the relative wind direction may not accurately represent the angle of the incoming flow. Additional calculations can determine this non-linearity and again correct the signal. Combined with references from nearby turbines that are not misaligned, an overall more accurate picture of the wind flow field is determined even when turbines are intentionally misaligned.

Disclosed systems and methods also can be used to eliminate unnecessary yaw movements, reducing energy consumption and wear and tear on the yaw drives of the turbines. These movements happen when turbines are yawing in windspeeds that are too low to start generating power or when the wind is oscillating back and forth, and the controller is unable to “keep up.”

Disclosed embodiments can be used in conjunction with systems and methods of controlling group or wind farm level yaw control behavior at a wind plant, as described in U.S. Pat. No. 11,639,710, issued May 2, 2023, and co-pending U.S. patent application Ser. No. 18/141,597, filed May 1, 2023, each of which is hereby incorporated by reference in its entirety.

An exemplary method of driving a nacelle to a target nacelle yaw position for a wind turbine is provided. The wind turbine includes a nacelle, an auxiliary yaw position control system, a turbine control unit, a yaw drive, and one or more wind direction sensors attached to the wind turbine. Exemplary method steps include receiving a first signal representing a current nacelle yaw position, receiving a second signal representing a target nacelle yaw position, and receiving a relative wind direction signal from the one or more wind direction sensors.

Exemplary methods comprise determining, based upon the current nacelle yaw position and the target nacelle yaw position, whether and in which direction the nacelle needs to move to be in the target nacelle yaw position. Then nacelle yaw actuation signals are sent to the turbine control unit. Exemplary methods comprise determining whether it is safe to accept the nacelle yaw actuation signals, and if so, commanding the yaw drive such that the nacelle remains in the current position or moves toward the target nacelle yaw position instead of commanding the yaw drive based on following the relative wind direction signal.

In exemplary embodiments, the nacelle yaw actuation signals comprise one or more of an enable input, a disable input, a directional input, and a stay-still input. Alternatively, the nacelle yaw actuation signals may comprise digital values. An exemplary method may further comprise detecting an error condition and sending the nacelle yaw actuation signals from the turbine control unit such that the turbine control unit remains in or returns to default mode commanding the yaw drive based on following the relative wind direction signal.

Exemplary embodiments may further comprise minimizing or eliminating unnecessary nacelle yaw position movements. For example, detecting a condition where the wind direction is oscillating faster than the turbine can accurately track, and thus the best performance is achieved by keeping the nacelle still using a longer duration average of the wind direction.

The nacelle yaw position signals may include an offset to account for a calibration error in the current nacelle yaw position. In exemplary embodiments, the current nacelle yaw position is determined using one or more GNSS antennas. Determining a calibration error may include averaging a difference between the signal from the turbine yaw transducer and the one or more GNSS antennas over time.

Exemplary methods of driving a nacelle to an optimized nacelle yaw position for a wind turbine is provided. The wind turbine includes a nacelle, an auxiliary yaw position control system, a turbine control unit, a yaw drive, and one or more wind direction sensors attached to the wind turbine. Exemplary method steps include receiving a first signal representing a current nacelle yaw position, receiving a second signal representing a target nacelle yaw position, and receiving a relative wind direction signal from one or more wind direction sensors. Command nacelle yaw position signals are sent to the turbine control unit. Exemplary methods include determining whether it is safe to accept the command nacelle yaw position signals, and if so, commanding the yaw drive such that the nacelle remains in or moves to the target nacelle yaw position instead of commanding the yaw drive based on following the relative wind direction signal.

In exemplary embodiments, based upon the current nacelle yaw position and the target nacelle yaw position, the command nacelle yaw position is determined relative to a fixed reference frame of the tower. The command nacelle yaw position signals may comprise one or more of an enable input, a disable input, a nacelle position in a fixed reference frame, or a nacelle position relative to the current nacelle position. Exemplary methods may further comprise determining a minimum distance required to start nacelle movement and to stop nacelle movement. Exemplary methods include minimizing or eliminating unnecessary nacelle yaw position movements. The current nacelle yaw position may be determined using one or more GNSS antennas. In exemplary embodiments, determining a calibration error comprises averaging a difference between the signal from the turbine yaw transducer and the one or more GNSS antennas over time.

An exemplary embodiment of a retrofit system for driving a nacelle to a target nacelle yaw position for a wind turbine also is provided and described herein. The wind turbine may include a nacelle, a turbine control unit, a yaw drive, and one or more wind direction sensors attached to the wind turbine. An exemplary retrofit system comprises an auxiliary yaw position control system configured to be communicatively coupled to the turbine control unit. The auxiliary yaw position control system receives a first signal representing a current nacelle yaw position and a second signal representing a target nacelle yaw position. The auxiliary yaw position control system determines, based upon the current nacelle yaw position and the target nacelle yaw position, whether and in which direction the nacelle needs to move to be in the target nacelle yaw position. The auxiliary yaw position control system sends command signals to the turbine control unit to command the yaw drive such that the nacelle moves or to stays still.

In exemplary embodiments, the retrofit system comprises one or more GNSS antennas in communication with the auxiliary yaw position control system and determines current nacelle yaw position in a global reference frame. This nacelle position measured using the GNSS antennas may be used in combination with a turbine yaw transducer to calibrate a signal from the turbine yaw transducer. The calibration comprises averaging a difference between the signal from the turbine yaw transducer and the one or more GNSS antennas over time to determine the offset of the turbine yaw transducer to the global reference frame. The retrofit system may also include an absolute encoder attached to the wind turbine.

In exemplary embodiments, the auxiliary yaw position control system sends a heartbeat or time-stamped information to the turbine control unit. A time out may then be implemented so that the turbine control unit returns to its original operation if new information or a recent heartbeat are not received, thus indicating a problem with the auxiliary yaw position control system.

Accordingly, it is seen that systems and methods of driving a nacelle to a target or optimized nacelle yaw position are provided. These and other features and advantages will be appreciated from review of the following detailed description, along with the accompanying figures in which like reference numbers refer to like parts throughout.

### BRIEF DESCRIPTION OF THE DRAWINGS

The foregoing and other objects of the disclosure will be apparent upon consideration of the following detailed description, taken in conjunction with the accompanying drawings, in which:

FIG. 1 is a perspective view of an exemplary embodiment of a wind plant in accordance with the present disclosure;

FIG. 2 is a side view of an exemplary embodiment of a wind turbine nacelle including an auxiliary yaw position control system installed between the existing wind direction sensor and the turbine control unit in accordance with the present disclosure;

FIG. 3 is a process flow diagram of an exemplary embodiment of an auxiliary yaw position control system for a wind turbine in accordance with the present disclosure;

FIG. 4 is a chart of exemplary digital output signals provided by an auxiliary yaw position control system for a wind turbine in accordance with the present disclosure;

FIG. 5 is a top view of an exemplary embodiment of a wind turbine nacelle with the addition of two GNSS antennas and a differential GNSS receiver that computes the relative position vector between the antennas to determine the current nacelle yaw position of the turbine relative to the wind plant layout;

FIG. 6 is a side view of an exemplary embodiment of a wind turbine nacelle showing an exemplary control system for a wind turbine including an auxiliary yaw position control system installed between the existing wind direction sensor and the turbine control unit with the addition of two GNSS antennas and a differential GNSS receiver in accordance with the present disclosure;

FIG. 7 is a process flow diagram of an exemplary control system and method of driving a nacelle to a target nacelle yaw position in accordance with the present disclosure;

FIG. 8 is a process flow diagram of an exemplary wind farm flow control system and method of driving a nacelle to a target nacelle yaw position in accordance with the present disclosure; and

FIG. 9 is a block diagram showing an exemplary embodiment of the internal structure of a computer in which various embodiments of the disclosure may be implemented.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure. As used herein, the “present disclosure” refers to any one of the embodiments described herein, and any equivalents. Furthermore, reference to various aspects of the disclosure throughout this document does not mean that all claimed embodiments or methods must include the referenced aspects.

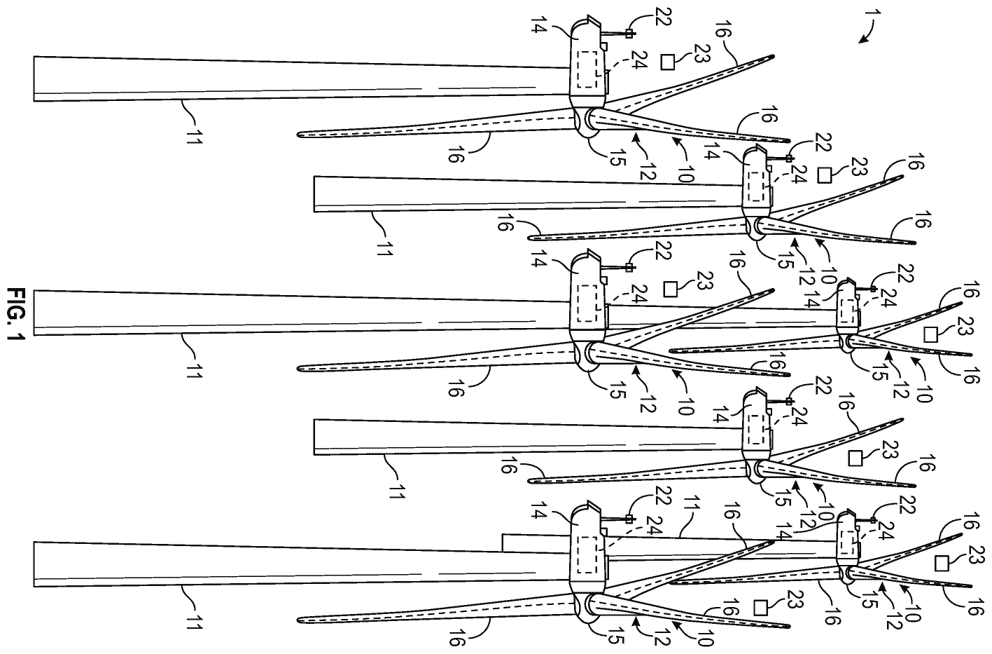

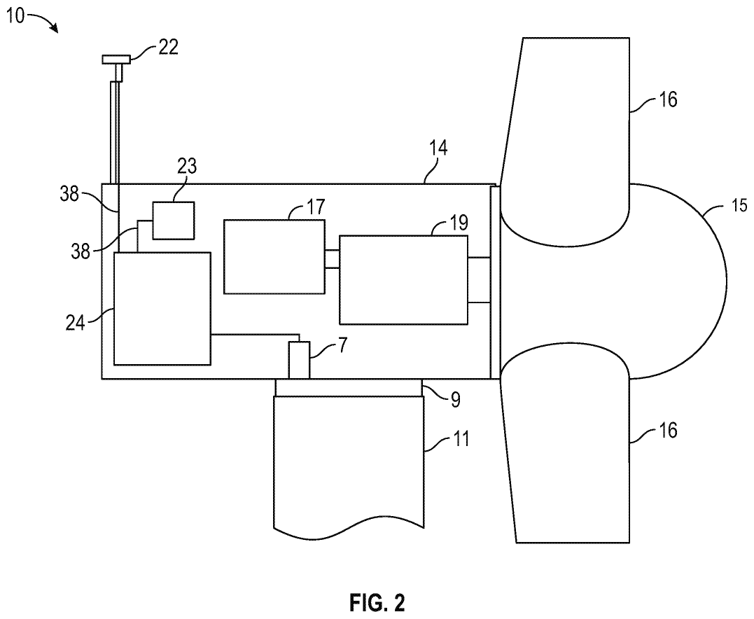

Embodiments of the present disclosure provide methods and systems of globally referenced yaw position control for a wind turbine. An exemplary wind farm 1 is shown in FIG. 1. A wind farm or wind plant 1 includes a plurality of wind turbines 10. Each wind turbine 10 has a tower 11, a rotor 12, and a nacelle 14 mounted to the top of the tower 11 along with a yaw bearing 9. The rotor 12 has a plurality of rotor blades 16 coupled to and extending from a rotor hub 15. The rotor hub 15 is rotatably coupled to an electric generator 17 via the main shaft 3. FIG. 2 illustrates the major components in the nacelle 14. Various mechanical, electrical and computer systems, including but not limited to, the electric generator 17, a gearbox 19, a yaw motor/drive 7, and a turbine control unit 24, may be housed in the nacelle 14. An auxiliary yaw position control system 23 embodying the methods described in this disclosure may be added to the wind turbine 10 or located remotely from the turbine. This auxiliary system 23 is an addition to the existing yaw controller software and hardware on the turbine that comprises the turbine control system.

Systems and methods of the present disclosure provide modified capabilities and functionality via the auxiliary yaw position control system 23 as follows. New types of communication with the existing turbine control unit 24 are added, enabling several new methods for the behavior of the combined system. The types of communication added are a set of digital IO signals 33 to command movement of the yaw drive 7 or communication of the actual target nacelle position in a mutually known reference frame (either based on the wind turbine's own measurement or a corrected nacelle position where an appropriate offset is provided to align the turbine with true north when at 0 degrees for example).

While some modifications to the existing turbine control unit 24 may be required to accept these digital signals, a significant advantage of this approach is that wind plant yaw control optimization may be implemented without fundamentally changing the wind turbine behavior and can be added using an additional network. Also, additional sensors may be added that are not part of the original turbine system.

Disclosed systems and methods include incorporating the auxiliary yaw position control system 23 into the wind turbine 10. The system 23 may be installed as a retrofit on an existing turbine or installed as new OEM equipment. It may be co-located in the nacelle with the wind turbine controller or potentially positioned at another location or at a central location. The auxiliary yaw position control system 23 is communicatively coupled with the wind turbine controller 24, receiving information about the present status of the turbine, including its measured relative wind direction, windspeed, power, and measured nacelle position, and potentially with additional sensors 22 including a wind direction sensor and a GNSS compass including GNSS antennas 30 and a GNSS differential receiver 32.

Disclosed systems and methods advantageously drive the nacelle 14 as quickly and accurately as possible to a target nacelle position 29, where the target nacelle position may be determined internally or provided from an external wind plant optimization. The present disclosure describes in detail how the system communicates with the turbine control unit 24. It should be noted that the additional system may be installed at the time of manufacture or as a retrofit system.

Referring to FIGS. 2, 5 and 6, the layout of the wind turbine 10 with an exemplary auxiliary yaw position control system 23 incorporated into a wind turbine or wind farm will now be described. Typically, a turbine control system is implemented using electrical circuitry including a PLC or industrial computer to perform the necessary calculations, determine if a fault state exists and provide fault state digital output. The turbine control systems and methods of present disclosure implement advanced yaw control of the wind turbine 10 via an auxiliary yaw position control system 23 communicatively coupled to the turbine control unit 24. The auxiliary yaw position control system 23 provides additional control over the wind turbine 10. In exemplary embodiments, the auxiliary yaw position control system 23 is installed between the wind direction sensor or sensors 22 and the turbine control unit 24. Signal and communication cables 38 may connect sensors 22 and the auxiliary yaw position control system 23 to the turbine control unit 24.

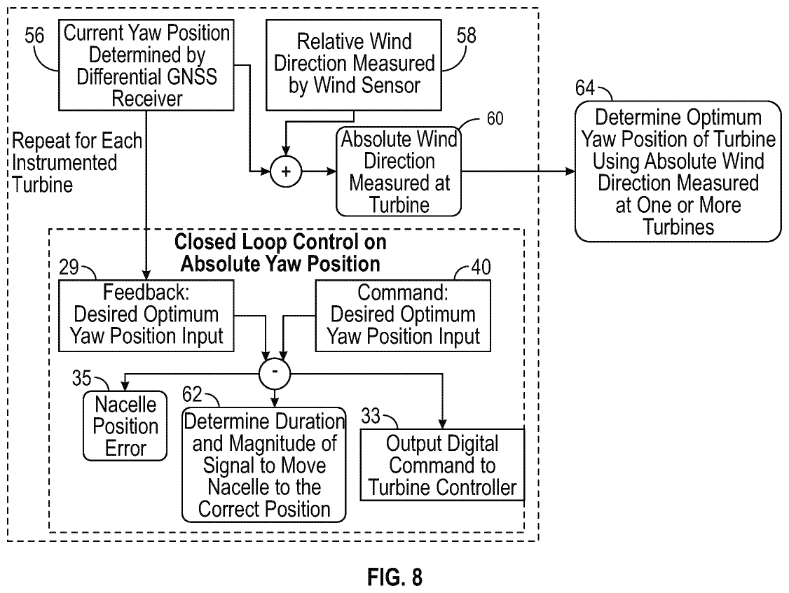

In exemplary embodiments, digital IO signals 33 are used for direct communication. The auxiliary yaw position control system 23 receives signals corresponding to the current nacelle yaw position 27 and the target nacelle yaw position 29. More particularly, it receives a first signal 27 representing the current nacelle yaw position of the wind turbine 10 and a second signal 29 representing a target nacelle yaw position. In addition, the auxiliary yaw position control system 23 receives a relative wind direction signal 39, measured 58 by the sensor 22. It then determines if the turbine should yaw left, yaw right, or stay where it is (creating a closed feedback control loop on nacelle position). An exemplary closed loop control process flow is shown in FIG. 8.

The auxiliary yaw position control system 23 sends a nacelle yaw actuation signal 33 determined from the current nacelle yaw position 27 and the target nacelle yaw position 29 of the turbine 10 to the turbine control unit 24 instead of the relative wind direction signal 39. As discussed in more detail herein, the target nacelle yaw position 29 may be computed and determined 64 using the relative wind direction 58, wind speed, and initial nacelle yaw position signals 27 for the wind turbine 10 or based on a plurality of signals for the entire wind plant. Measuring the wind direction and nacelle position accurately in a global reference frame is important for the correct function of the system both to determine the target nacelle yaw position and then to execute moving the nacelle to that position. As discussed in more detail herein, differential GNSS may be used to determine the true nacelle direction or to calibrate the relative nacelle position measurement used by the turbine control unit 24.

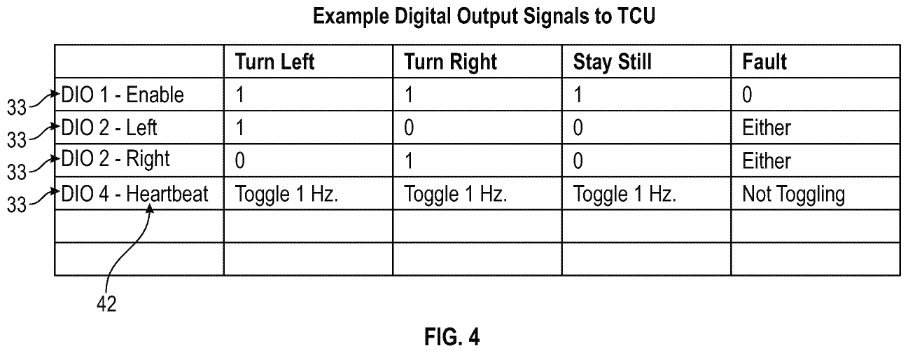

In exemplary embodiments, the digital IO signals 33 communicate with the turbine control unit 24 by providing “enable” and “go-left” and/or “go-right” signals. These depend, among other factors, on the current nacelle yaw position 27 and whether there is a nacelle position difference 35 between current and target nacelle yaw position 29. Thus, the auxiliary yaw position control system 23 sends an “enable” and “go-left”, “go-right” or “stay still” input to the turbine control unit 24 depending on whether the nacelle 14 should move 37 and, if so, in which direction. If both “go-left” and “go-right” are in the low state, then the turbine should “stay still.” In this case, the auxiliary yaw position control system 23 is still responsible for closing the loop on global nacelle position. Exemplary digital output signals 33 can be seen in FIG. 4.

However, if there is an error condition or direct control is not desired in the current environmental situation, then the “enable” signal is set to low and the turbine control unit 24 will return to its previous behavior using the relative wind direction feedback from its own sensor 22 to determine the yaw drive behavior and nominally attempt to point the wind turbine 10 into the locally measured wind direction 60. The turbine control unit 24 also may determine if it is a safe situation to accept these inputs and commands the yaw drives 7 accordingly. Should the turbine control unit 24 determine that an unsafe operating condition is present, then it may ignore the enable signal 34 and proceed with the prior behavior of the yaw drives. If the auxiliary yaw position control system 23 detects an error condition, then the enable signal 34 is not set to zero and the turbine control unit 24 returns to default behavior using the local wind direction signal to determine the behavior of the yaw drives 7. The ability to return to non-wind farm flow control remains with the turbine control unit 24 although an “enable-off” type signal may be provided by the auxiliary yaw position control system 23 to achieve this as well.

In exemplary embodiments, upon receiving signals corresponding to the current nacelle yaw position 27 and the optimized target nacelle yaw position 29, the auxiliary yaw position control system 23 determines a command nacelle yaw position 40 to tell the turbine control unit 24 relative to an internal reference frame. This typically would be the fixed reference frame of the tower 11. The auxiliary yaw position control system 23 sends the command nacelle yaw position signals to the turbine control unit 24. The turbine control unit 24 will then actuate to move the turbine 14 to that position if it is safe to do so. In exemplary embodiments, timestamped information or a heartbeat 42 are provided so that both systems know if they have lost communication with the other system and thus have old information. In that case, the system 23 or the turbine control unit 24 can take appropriate action to mitigate the situation, typically by returning to the default yaw behavior.

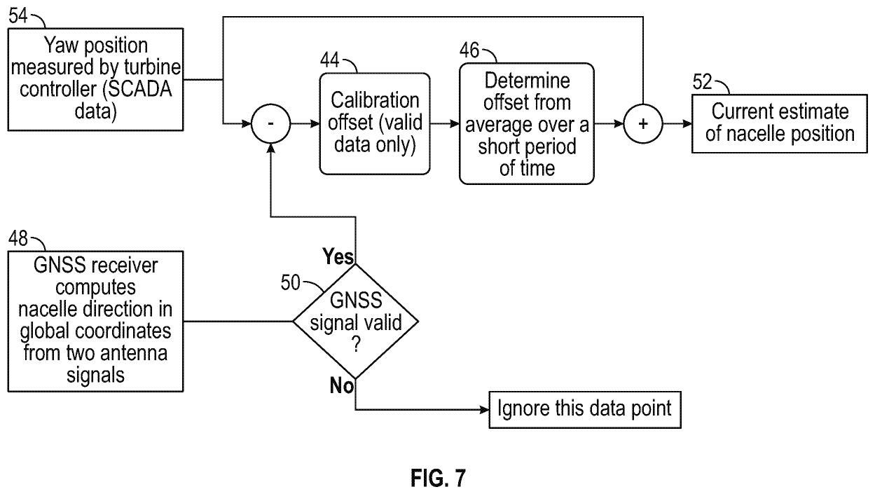

In exemplary embodiments, the auxiliary yaw position control system 23 commands the turbine 10 to go to a specific nacelle position. There are two ways to ensure that the turbine is directed to the correct position 62 in the global reference frame (relative to the tower). One is for the auxiliary yaw position control system 23 to provide both the commanded new location 40 and the current position 52 as determined through a combination of signals 48 and 54 as illustrated in FIGS. 7 and 8. These values are updated at a high enough frequency to enable the turbine control unit 24 to use the reference current position as the feedback signal in closing the loop on nacelle position. Another is for the auxiliary yaw position control system 23 to “uncalibrate” the target position to be in the current local measurement coordinate of the turbine control unit 24 yaw sensor. Thus, the offset 46 between the true nacelle yaw position in global reference frame and the nacelle yaw position measured by the turbine control unit 24 is subtracted from the target commanded nacelle yaw position 29 prior to providing it to the turbine control unit 24.

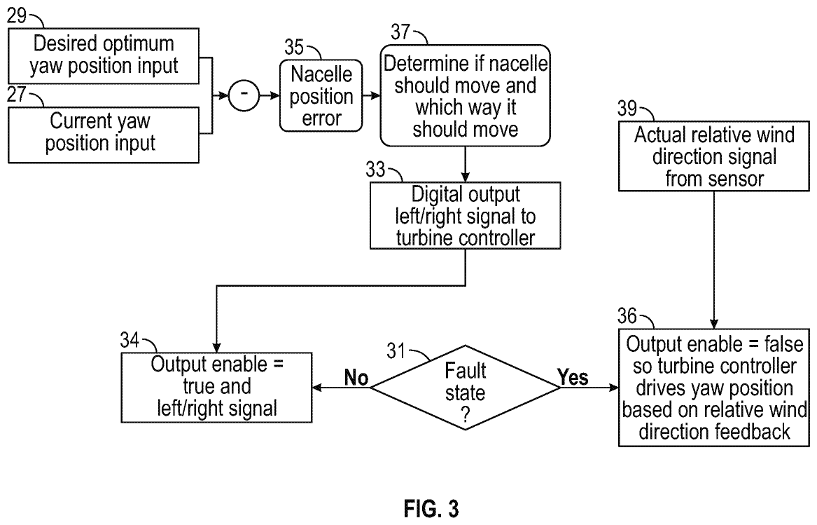

Referring to FIGS. 3, 7 and 8, in exemplary embodiments the auxiliary yaw position control system 23 provides the target nacelle position 29 digitally and may also provide the current nacelle position corrected for any offsets measured 46. Alternatively, it may provide the target nacelle position 29 with an offset to account for a calibration error on the turbine's own measurement of nacelle position. The current nacelle yaw position 27 may be measured 54 by the turbine control unit or determined 56 by the differential GNSS receiver 32.

As discussed above, an enable or disable indication also is provided. These signals may be communicated digitally using an interface that supports communication of integer values. This could be, e.g., a serial, profinet, ethercat, or ethernet based network communication and any message encoding system could be used that is mutually agreed between the turbine control unit 24 and the auxiliary yaw position control system 23. In such an implementation, the auxiliary yaw position control system 23 need not be co-located with the turbine control unit 24 and may instead be situated at a central location within the wind plant or on a remote server. Again, should an error condition or safety hazard be identified by either the auxiliary yaw position control system 23 or the turbine control unit 24, the turbine control unit may then return to its original operation 36.

The auxiliary yaw position control system 23 may modify the received or calculated target nacelle position 29 to optimize wind plant performance while simultaneously minimizing the number of nacelle position movements and thus the wear and tear on the yaw drive 7. In the case of digital signals 33 indicating the yaw direction desired, the command to move may be delayed for small moves until the difference between the current position and the target is large enough. In the case of a commanded nacelle position the signal could be maintained at the present position until the difference between that and the desired or target position is large enough and then the new value provided all at once and again held constant. Time between moves may also be a factor in determining the minimum move that should be attempted.

In the case where a digital left/right/stop signal is provided to the turbine control unit 24 to directly signal what the yaw drive 7 should do, additional functionality in the additional system may be provided to accurately position the nacelle 14. A minimum distance, which is required both to start the yaw drive 7 moving and to stop it again, may be determined and movements smaller than this will not be attempted. Furthermore, once the nacelle 14 is moving, it may continue to move for a short period of time after the stop command is provided. This additional movement should be determined and accounted for so the appropriate duration and magnitude for movement 62 to the correct position is signaled and a stop command can be provided in advance of reaching the target position.

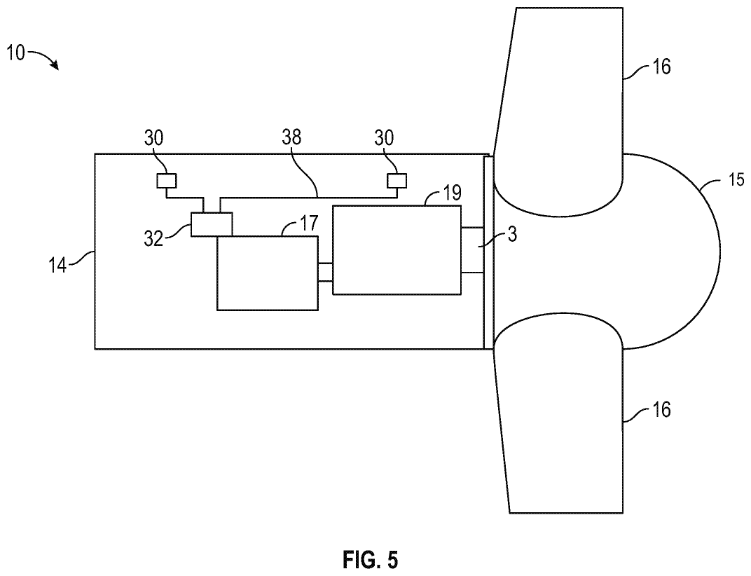

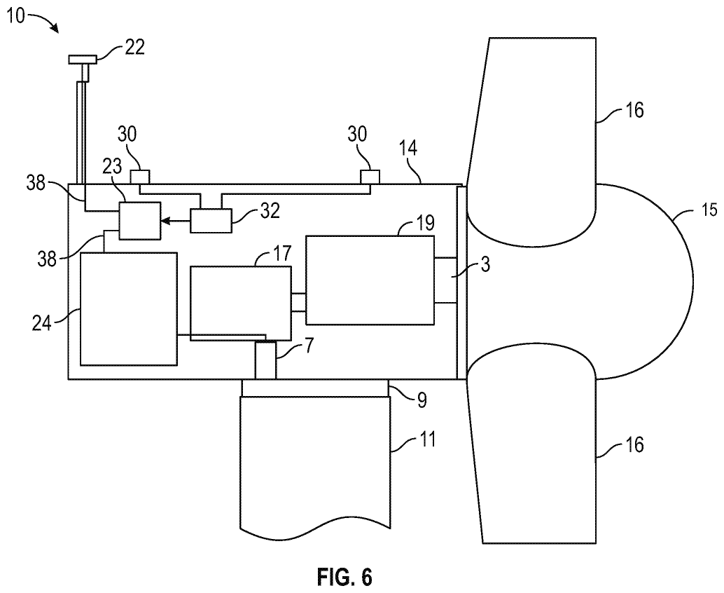

Turning to FIGS. 5 and 6, GPS or GNSS antennas 30 or other means of determining the nacelle position in a global reference frame may be used. In exemplary embodiments, the antennas 30 are positioned axially in line with the main shaft 3 of the wind turbine 10 but may be mounted at any angle relative to the main shaft 3, parallel, perpendicular, or other known angles. In exemplary embodiments, GNSS antennas 30 are mounted at a fixed distance apart on the nacelle 14 and a differential GNSS receiver 32 is used to determine the relative position vector between the GNSS antennas 30.

The auxiliary yaw position control system 23 and potentially the turbine control unit 24 need to know their yaw position accurately with respect to the fixed reference frame of the tower 11 and the surrounding wind plant 1. This is required to coordinate the yaw position of all turbines 10, not only relative to the local wind direction but relative to where the other turbines are to effect wake steering and other flow control optimizations such as collective and predictive yaw. Unfortunately, most wind turbines 10 as built do not have a yaw position transducer that can provide the position of the nacelle 14 with respect to a fixed reference frame. Although these transducers may be calibrated, the calibration is often lost and, on some turbines, changes frequently when the encoder miscounts the signals from the transducers.

Several methods may be incorporated to upgrade the turbine measurement capabilities. An absolute encoder may be installed (one that doesn't lose its position during a loss of power or computer memory). However, calibration of that transducer relative to a fixed direction such as true north is still required. Performing these calibrations is a challenging manual task. An alternative that does not require manual calibration to an outside reference is to use a differential GNSS satellite receiver with GNSS antennas 30. These antenna and receiver systems can provide accurate yaw position relative to the global reference frame but can only do so some of the time (typical up-times are 60-90%).

Thus, the GNSS differential receiver 32 and antennas 30 alone do not generally provide a reliable feedback signal. However, when its signal 48 is valid 50, it is possible to use it to calibrate the signal from the turbine yaw transducer by averaging 46 the difference between the yaw transducer signal and the GNSS antenna 30 over a short period of time and thereby providing a current estimate 52 of nacelle position, as illustrated in FIG. 7. The GNSS differential receiver 32 itself may provide a signal indicating sufficient satellite information is received and thus the signal is valid. Additional checks may be performed to check the signal, e.g., checking that the rotational velocity is within the physical limits of the turbine. Typically, these measurements are made while the turbine is not moving to improve accuracy of the calibration offset 44 calculated.

If the calibration is performed frequently enough and the value updated in the calculation 48 of the true nacelle position, then the feedback will be reliable. Thus, offsets between the GNSS or globally measured position and the current local measurement 54 of nacelle yaw position by the turbine control unit may be determined. These offsets can then be used to determine the target position or command that is sent to the turbine control unit. But if the GNSS compass signal is lost for too long a period of time, then the calibration should be considered lost.

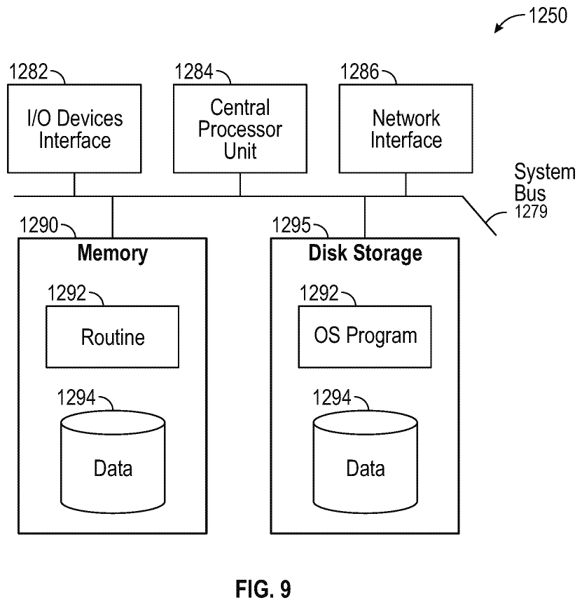

FIG. 9 shows an exemplary internal structure of a computer 1250 in which various embodiments of the present disclosure may be implemented. For example, the computer 1250 may act as a coordinated yaw controller. The computer 1250 contains a system bus 1279, where a bus is a set of hardware lines used for data transfer among the components of a computer or processing system. Bus 1279 is essentially a shared conduit that connects different elements of a computer system (e.g., processor, disk storage, memory, input/output ports, network ports, etc.) that enables the transfer of information between the elements. Attached to system bus 1279 is I/O device interface 1282 for connecting various input and output devices (e.g., sensors, transducers, keyboard, mouse, displays, printers, speakers, etc.) to the computer 1250. Network interface 1286 allows the computer 1250 to connect to various other devices attached to a network (e.g., wind farm system, SCADA system, wind farm controller, individual turbine control units, weather condition sensors, data acquisition system etc.).

Memory 1090 provides volatile storage for computer software instructions 1292 (e.g., instructions for the processes/calculations described above) and data 1294 used to implement an embodiment of the present disclosure. Disk storage 1295 provides non-volatile storage for computer software instructions 1292 and data 1294 used to implement an embodiment of the present disclosure. Central processor unit 1284 is also attached to system bus 1279 and provides for the execution of computer instructions.

In an exemplary embodiment, the processor routines 1292 (e.g., instructions for the processes/calculations described above) and data 1094 are a computer program product (generally referenced 1292), including a computer readable medium (e.g., a removable storage medium such as one or more DVD-ROMs, CD-ROMs, diskettes, tapes, etc.) that provides at least a portion of the software instructions for the invention system. Computer program product 1292 can be installed by any suitable software installation procedure, as is well known in the art.

In another embodiment, at least a portion of the software instructions may also be downloaded over a cable, communication and/or wireless connection. Further, the present embodiments may be implemented in a variety of computer architectures. The computer of FIG. 9 is for purposes of illustration and not limitation of the present disclosure. In some embodiments of the present disclosure, the data analysis and auxiliary control system may function as a computer to perform aspects of the present disclosure.

Thus, it is seen that systems and methods of driving a nacelle to a target nacelle yaw position are provided. It should be understood that the example embodiments described above may be implemented in many different ways. In some instances, the various methods and machines described herein may each be implemented by a physical, virtual or hybrid general purpose computer having a central processor, memory, disk or other mass storage, communication interface(s), input/output (I/O) device(s), and other peripherals. The general purpose computer is transformed into the machines that execute the methods described above, for example, by loading software instructions into a data processor, and then causing execution of the instructions to carry out the functions described, herein. Embodiments may therefore typically be implemented in hardware, firmware, software, or any combination thereof.

While embodiments of the disclosure have been particularly shown and described with references to example embodiments thereof, it will be understood by those skilled in the art that various changes in form and details may be made therein without departing from the scope of the invention encompassed by the appended claims. For example, the disclosed augmented control is described in the context of wind farms and wind turbines, but may be applied to augment control of other turbines, such underwater turbines.

What is claimed is:

1. A method of driving a nacelle to a target nacelle yaw position for a wind turbine including a nacelle, an auxiliary yaw position control system, a turbine control unit, a yaw drive, and one or more wind direction sensors attached to the wind turbine, the method comprising:
receiving a first signal representing a current nacelle yaw position;
receiving a second signal representing a target nacelle yaw position;
receiving a relative wind direction signal from the one or more wind direction sensors;
determining, based upon the current nacelle yaw position and the target nacelle yaw position, whether and in which direction the nacelle needs to move to be in the target nacelle yaw position;
sending nacelle yaw actuation signals to the turbine control unit;
determining whether it is safe to accept the nacelle yaw actuation signals; and
if it is safe to accept the nacelle yaw actuation signals, commanding the yaw drive such that the nacelle remains in its current position or moves toward the target nacelle yaw position instead of commanding the yaw drive based on following the relative wind direction signal.

2. The method of claim 1 wherein the nacelle yaw actuation signals comprise one or more of: an enable input, a disable input, a directional input, and a stay-still input.

3. The method of claim 1 wherein the nacelle yaw actuation signals comprise digital values.

4. The method of claim 1 further comprising detecting an error condition and sending the nacelle yaw actuation signals from the turbine control unit such that the turbine control unit remains in or returns to default mode commanding the yaw drive based on following the relative wind direction signal.

5. The method of claim 1 further comprising minimizing or eliminating unnecessary nacelle yaw position movements.

6. The method of claim 1 wherein the nacelle yaw actuation signals include an offset to account for a calibration error in the current nacelle yaw position.

7. The method of claim 1 wherein the current nacelle yaw position is determined using one or more GNSS antennas.

8. The method of claim 7 wherein determining a calibration error comprises averaging a difference between the signal from a turbine yaw transducer and the one or more GNSS antennas over time.

9. A method of driving a nacelle to an optimized nacelle yaw position for a wind turbine including a tower, a nacelle, an auxiliary yaw position control system, a turbine control unit, a yaw drive, and one or more wind direction sensors attached to the wind turbine, the method comprising:
receiving a first signal representing a current nacelle yaw position;
receiving a second signal representing a target nacelle yaw position;
receiving a relative wind direction signal from the one or more wind direction sensors;
sending command nacelle yaw actuation signals to the turbine control unit;
determining whether it is safe to accept the command nacelle yaw actuation signals; and
if it is safe to accept the command nacelle yaw actuation signals, commanding the yaw drive such that the nacelle remains in or moves to the target nacelle yaw position instead of commanding the yaw drive based on following the relative wind direction signal.

10. The method of claim 9, wherein, based upon the current nacelle yaw position and the target nacelle yaw position, the command nacelle yaw position is determined relative to a fixed reference frame of the tower.

11. The method of claim 9 wherein the command nacelle yaw actuation signals comprise one or more of: an enable input, a disable input, a nacelle yaw position in a fixed reference frame, and a nacelle position relative to the current nacelle yaw position.

12. The method of claim 9 further comprising determining a minimum distance required to start nacelle movement and to stop nacelle movement.

13. The method of claim 9 further comprising minimizing or eliminating unnecessary nacelle yaw position movements.

14. The method of claim 9 wherein the optimized nacelle yaw position is determined using one or more GNSS antennas.

15. The method of claim 14 wherein determining a calibration error comprises averaging a difference between a signal from a turbine yaw transducer and the one or more GNSS antennas over time.

16. A retrofit system for driving a nacelle to a target nacelle yaw position for a wind turbine including a nacelle, a turbine control unit, a yaw drive, and one or more wind direction sensors attached to the wind turbine, the system comprising:
an auxiliary yaw position control system configured to be communicatively coupled to the turbine control unit, the auxiliary yaw position control system receiving a first signal representing a current nacelle yaw position, a second signal representing a target nacelle yaw position, and a relative wind direction signal from the one or more wind direction sensors;
wherein the auxiliary yaw position control system determines, based upon the current nacelle yaw position and the target nacelle yaw position, whether and in which direction the nacelle needs to move to be in the target nacelle yaw position; and
wherein the auxiliary yaw position control system sends command signals to the turbine control unit to command the yaw drive such that the nacelle moves or stays still.

17. The retrofit system of claim 16 further comprising one or more GNSS antennas in communication with the auxiliary yaw position control system, the one or more GNSS antennas determining the current nacelle yaw position in a global reference frame.

18. The retrofit system of claim 17 further comprising a turbine yaw transducer;
wherein the current nacelle yaw position is calibrated by averaging a difference between a signal from the turbine yaw transducer and the one or more GNSS antennas over time.

19. The retrofit system of claim 16 further comprising an absolute encoder attached to the wind turbine.

20. The retrofit system of claim 16 wherein the auxiliary yaw position control system sends a heartbeat or time-stamped information to the turbine control unit.
